(19) United States
(12) Patent Application Publication
(10) Pub. No.: US 2014/0300824 A1
(43) Pub. Date: Oct. 9, 2014

(54) Method of Channel Characterization for Mobile ATSC HDTV Receiver

(71) Applicant: Lin Yang, Milpitas, CA (US)

(72) Inventor: Lin Yang, Milpitas, CA (US)

(21) Appl. No.: 13/889,158

(22) Filed: May 7, 2013

Related U.S. Application Data
(60) Provisional application No. 61/808,484, filed on Apr. 4, 2013.

(51) Int. Cl. H04N 5/44

(52) U.S. Cl. CPC H04N 5/44
USPC 348/731; 348/725

(57) ABSTRACT

This invention is a method to quickly characterize the time variant channel state information to enable ATSC HDTV signal reception in a mobile environment (e.g. in a moving car, walking, on a bus, etc.) by removing the Doppler interference. The invention relates to a single or multiple antenna ATSC terrestrial DTV receiver for indoor and mobile users.

This application claims the benefit of the U.S. Provisional application No. 61/808,484, filed Apr. 4, 2013.

### TECHNICAL FIELD

The present invention relates generally to an application in a digital television system, more specifically the present invention relates to a single or multiple antenna ATSC terrestrial DTV receivers for indoor and mobile users.

### BACKGROUND

Traditionally, terrestrial ATSC HDTV programming can only be viewed on a TV console in a fixed or static environment (e.g. family room).

Today, mobile devices with screens are ubiquitous. Examples include, but are not limited to; laptops, tablets, cell phones, car infotainment systems, etc. However, terrestrial ATSC HDTV programming cannot be viewed on these devices in a mobile environment. This is because existing ATSC HDTV receivers cannot have stable reception in a mobile environment due to the Doppler interference caused by mobile conditions.

In order to remove the Doppler interference caused by mobile conditions, a method to quickly estimate the terrestrial ATSC HDTV transmission channel characteristics is needed.

The following patents are herein incorporated by reference: U.S. patent application Ser. No. 12/512,901 entitled A NOVEL EQUALIZER FOR SINGLE CARRIER TERRESTRIAL DTV RECEIVER, by Yang; U.S. patent application Ser. No. 12/554,925 entitled A MULTIPLE TUNER ATSC TERRESTRIAL RECEIVER FOR INDOOR & MOBILE USERS, by Yang; U.S. patent application Ser. No. 12/572,236 entitled A MULTIPLE TUNER TERRESTRIAL DTV RECEIVER FOR INDOOR & MOBILE USERS, by Yang; U.S. patent application Ser. No. 13/871,869 entitled WI-FI ATSC TV ANTENNA, by Yang; and U.S. patent application Ser. No. 13/872,917 entitled MULTIPLE ANTENNA ATSC HDTV RECEIVER DEVICE, by Yang.

The prior art made of record and not relied upon are hereupon disclosed: United States patent number 20100273427, by Mergen, which discloses a method and apparatus for filtering noisy estimates to reduce estimation errors; and United States patent number 20130114767, by Lee, which shows an apparatus and method for enhancing channel estimation accuracy in communication systems.

In addition to the above-referenced applications, the present invention adds the following functions: The function of Time Domain Iterative Channel Impulse Response Estimator & Signal-To-Noise Ratio Estimator, and The function of Weighted Combining Unit for Channel Impulse Response.

### SUMMARY OF INVENTION

This invention is a method to quickly estimate the terrestrial ATSC HDTV transmission channel characteristics in order to remove the Doppler interference present in a mobile situation.

### BRIEF DESCRIPTION OF DRAWINGS

Having thus described the invention in general terms, reference will now be made to the accompanying drawings, which are not necessarily drawn to scale, and wherein:

FIG. 1 shows an example of A Terrestrial ATSC HDTV Receiver.

FIG. 2 shows the Channel State Information Estimator & Signal-To-Noise Ratio Estimator.

FIG. 3 shows a single antenna being coupled to a single tuner.

FIG. 4 shows a single antenna being coupled to a plurality of tuners.

FIG. 5 shows a plurality of antennas being coupled to a plurality of tuners.

FIG. 6 shows a single Wi-Fi ATSC TV antenna.

FIG. 7 shows a plurality Wi-Fi ATSC Antennas.

### DETAILED DESCRIPTION

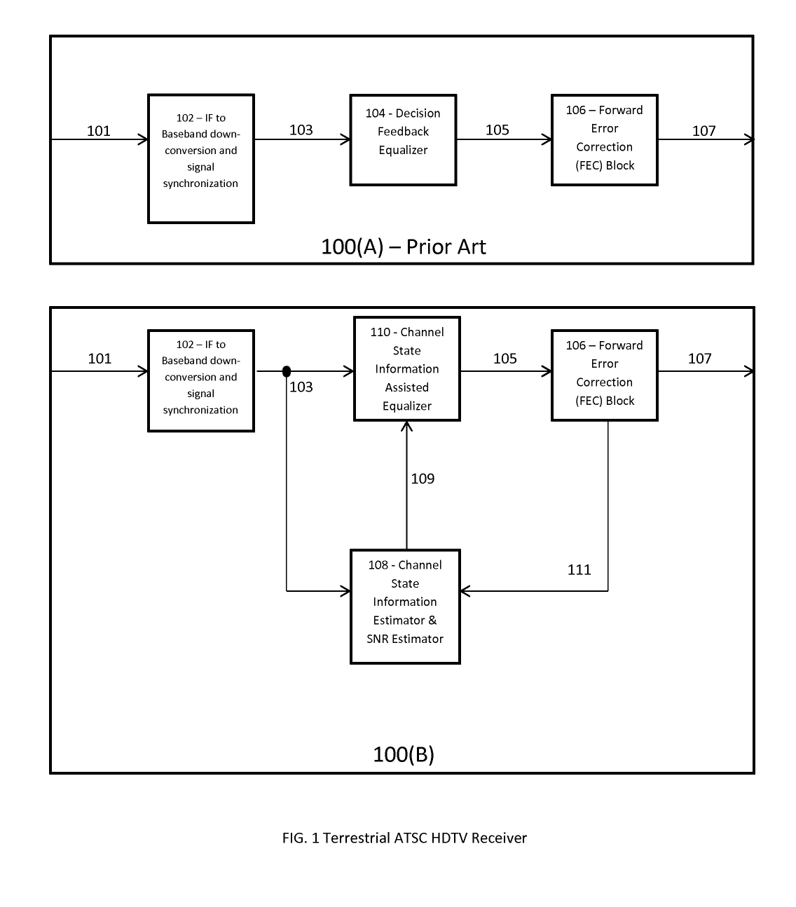

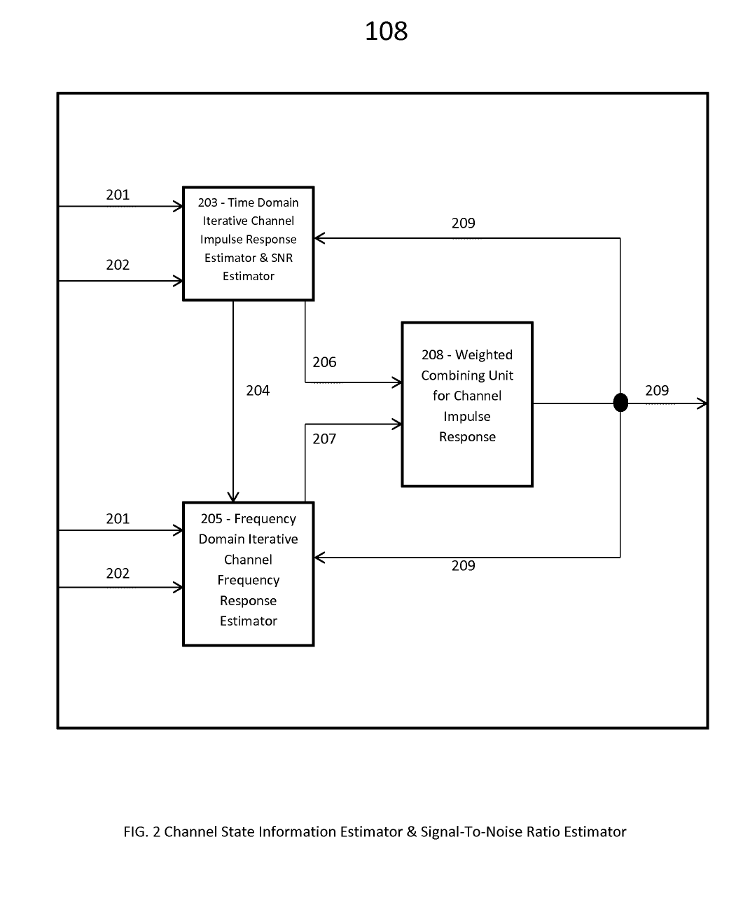

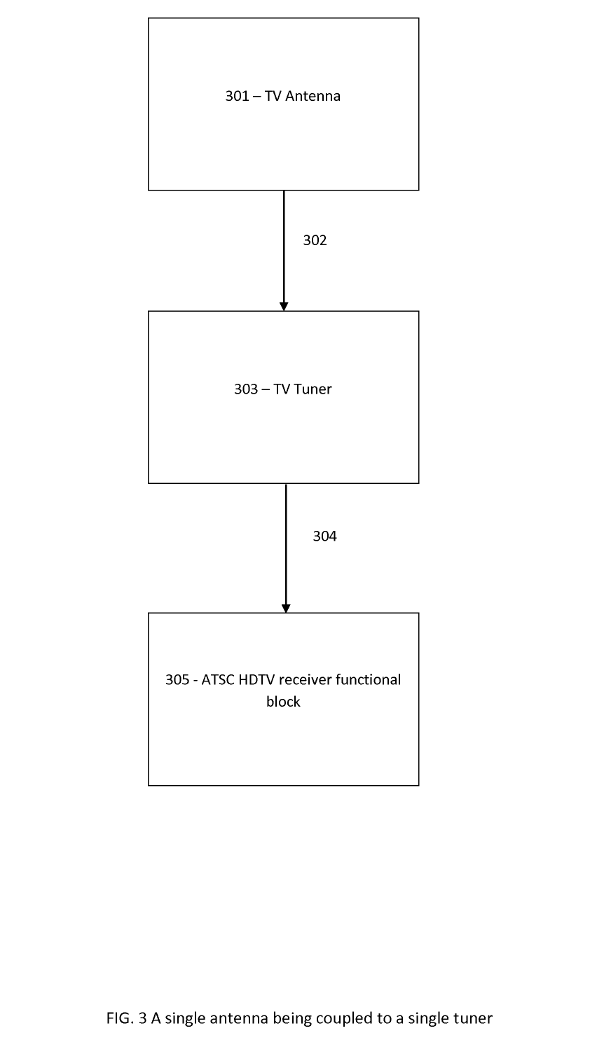

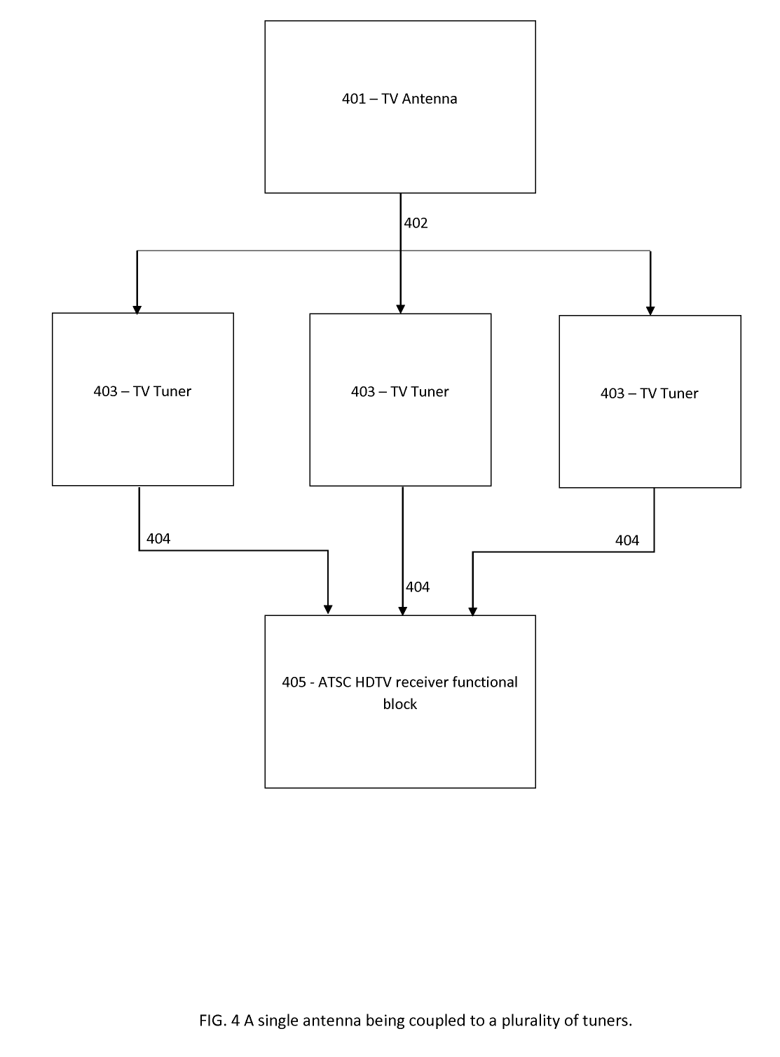

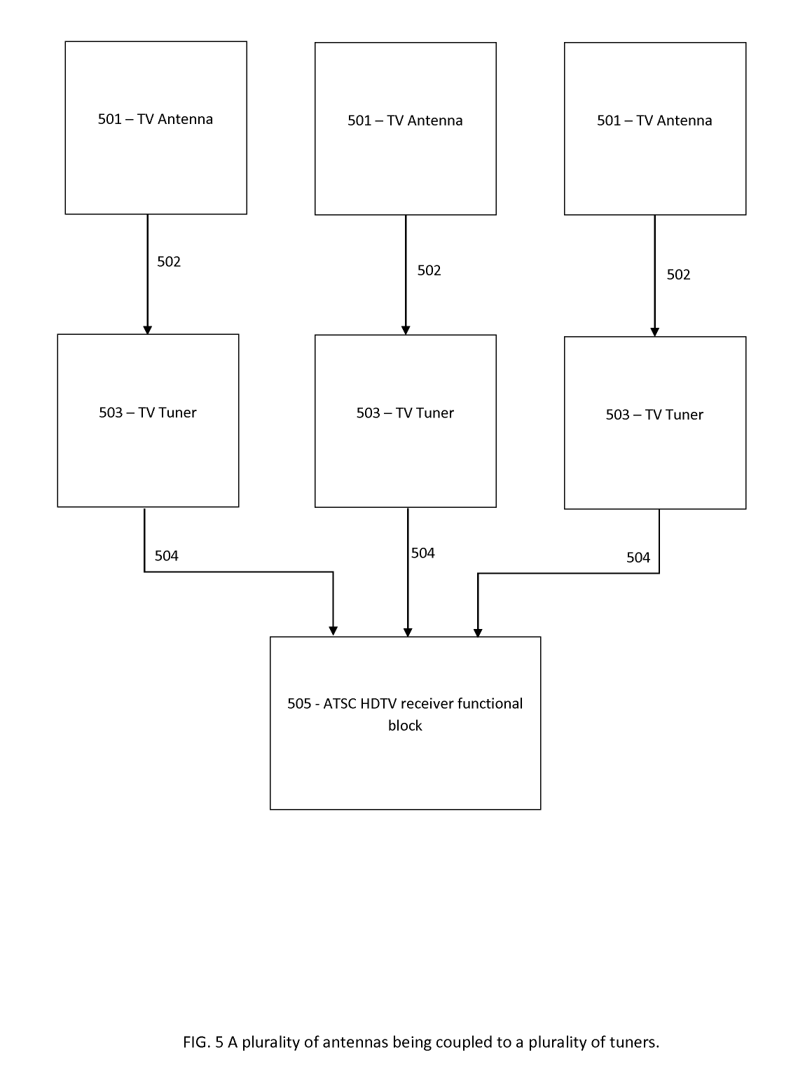

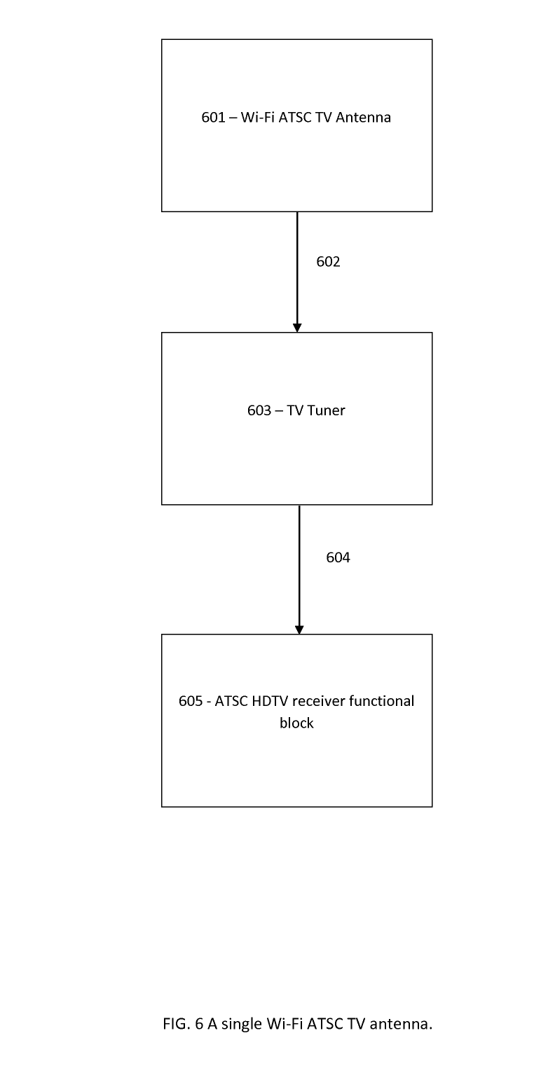

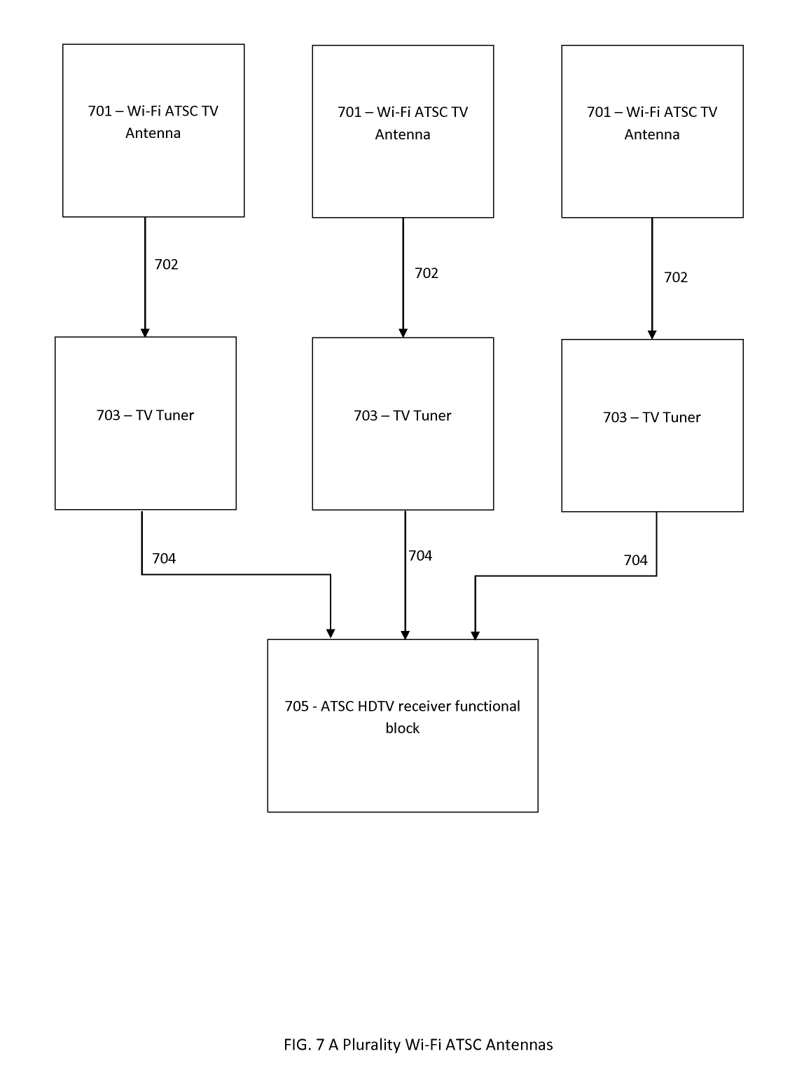

The present inventions now will be described more fully hereinafter with reference to the accompanying drawings, in which some examples of the embodiments of the inventions are shown. Indeed, these inventions may be embodied in many different forms and should not be construed as limited to the embodiments set forth herein; rather, these embodiments are provided by way of example so that this disclosure will satisfy applicable legal requirements. Like numbers refer to like elements throughout.
FIG. 1
   100—Terrestrial ATSC HDTV Receiver (an example)
      100(A) shows prior art
      100(B) shows an example of a new ATSC HDTV receiver functional block diagram applying this invention
   101—Digital ATSC IF Signal
   102—IF to Baseband down-conversion and signal synchronization. Includes but not limited to frequency shifting, low-pass filter, symbol timing recovery, carrier recovery, SRRC filter, Field Synchronization, segment synchronization
   103—Synchronized baseband ATSC HDTV signal
   104—Decision Feedback Equalizer
   105—Demodulated ATSC HDTV Signal
   106—Forward Error Correction (FEC) Block: includes Viterbi Decoder, De-interleaver, R.S. Decoder, and De-randomizer
   107—MPEG TS (Transport Stream)
   108—Channel State Information Estimator & SNR (Signal-To-Noise Ratio) Estimator
   109—Channel State Information
   110—Channel State Information Assisted Equalizer
   111—Decoded ATSC HDTV Signal
FIG. 2—108
   201 (also 103 in FIG. 1)—Synchronized baseband ATSC HDTV signal
   202 (also 111 in FIG. 1)—Decoded ATSC HDTV Signal
   203—Time Domain Iterative Channel Impulse Response Estimator & SNR Estimator
   204—Initial Channel Impulse Response
   205—Frequency Domain Iterative Channel Frequency Response Estimator
   206—Channel Impulse Response and SNR
   207—Channel Impulse Response
   208—Weighted Combining Unit for Channel Impulse Response
   209 (also 109 in FIG. 1)—Channel State Information
FIG. 3
   301—TV Antenna
   302—Wired Connection
   303—TV Tuner
   304 (also 101 in FIG. 1)—Digital ATSC IF Signal
   305 (also 100B in FIG. 1)—ATSC HDTV receiver functional block
FIG. 4
   401—TV Antenna
   402—Wired Connection
   403—TV Tuner
   404 (also 101 in FIG. 1)—Digital ATSC IF Signal
   405 (also 100B in FIG. 1)—ATSC HDTV receiver functional block
FIG. 5
   501—TV Antenna
   502—Wired Connection
   503—TV Tuner
   504 (also 101 in FIG. 1)—Digital ATSC IF Signal
   505 (also 100B in FIG. 1)—ATSC HDTV receiver functional block
FIG. 6
   601—Wi-Fi ATSC TV Antenna
   602—Wi-Fi Connection
   603—TV Tuner
   604 (also 101 in FIG. 1)—Digital ATSC IF Signal
   605 (also 100B in FIG. 1)—ATSC HDTV receiver functional block
FIG. 7
   701—Wi-Fi ATSC TV Antenna
   702—Wi-Fi Connection
   703—TV Tuner
   704 (also 101 in FIG. 1)—Digital ATSC IF Signal
   705 (also 100B in FIG. 1)—ATSC HDTV receiver functional block

FIG. 1-100(A), prior art, is an example of a traditional ATSC HDTV receiver functional block diagram.

The digital ATSC IF Signal (101) goes in to the functional block (102) which performs the following functions: IF to Baseband down-conversion and signal synchronization. Includes but not limited to frequency shifting, low-pass filter, symbol timing recovery, carrier recovery, SRRC filter, Field Synchronization, and segment synchronization.

The output of functional block (102) is a synchronized baseband ATSC HDTV signal (103), which goes in to a decision feedback equalizer (104). The demodulated ATSC HDTV Signal (105) from the decision feedback equalizer (104) goes in to the Forward Error Correction Block (106), which performs the following functions: Viterbi Decoder, De-interleaver, R.S. Decoder, and De-randomizer, and then generates the MPEG TS (107).

FIG. 1-100(B) is an example of a new ATSC HDTV receiver functional block diagram applying this invention.

The invention replaces the traditional decision feedback equalizer (104) in FIG. 1(A) with the Channel State Information Estimator & SNR Estimator (108) and Channel State Information Assisted Equalizer (110).

The channel state information (109) is generated from the Channel State Information Estimator & SNR Estimator (108) based on the synchronized baseband ATSC HDTV signal (103) and the decoded ATSC HDTV signal (111).

FIG. 2:

The ATSC field-sync sequence in the Synchronized baseband ATSC HDTV signal (201) and the decoded ATSC HDTV signal (202) goes in to the Time Domain Iterative Channel Impulse Response Estimator in (203) to initialize and update the channel impulse response (204). The Time Domain Iterative Channel Impulse Response Estimator in (203) is using either the Least Means Square (LMS) or the Recursive Least Square (RLS) algorithm. The channel impulse response of (209) is time variant in mobile environments. Therefore, (203) is using previously estimated channel impulse response (209) as a reference to iteratively update the time variant channel impulse response. Because of the time variant nature of the channel impulse response in the mobile ATSC HDTV reception environment, a decoded ATSC HDTV signal (203) must be used in between the field sync signals in (201). The output of the Time Domain Iterative Channel Impulse Response Estimator & SNR Estimator (203) is Channel Impulse Response and SNR (206), which goes to Weighted Combining of Channel Impulse Response (208).

Optionally, in addition to using a Time Domain Iterative Channel Impulse Response Estimator & SNR Estimator (203), a Frequency Domain Iterative Channel Frequency Response Estimator (205) can be used, given the initial channel impulse response (204).

In the Frequency Domain Iterative Channel Frequency Response Estimator (205), the following algorithm is used:
1. Zero padding guard interval data segment reference signal generation
2. Pre-segment and post-segment data removal of the Synchronized baseband ATSC HDTV signal (201) for each segment
3. Fast Fourier Transform (FFT) and Inverse Fast Fourier Transform (IFFT) are used to do the transformation between channel impulse response and frequency response

The output channel impulse response (207) is generated from Frequency Domain Iterative Channel Frequency Response Estimator (205) and fed in to the Weighted Combining Unit for Channel Impulse Response (208).

The Weighted Combining Unit for Channel Impulse Response (208) combines Channel Impulse Response and SNR (206) and Channel Impulse Response (207) using a novel weighting algorithm to generate channel state information (209) which is a combined channel impulse response and SNR for each signal segment.

FIG. 3 shows a single antenna being coupled to a single tuner. A single TV Antenna (301) connects to a single TV Tuner (303) by a wired connection (302). The TV Tuner (303) outputs a Digital ATSC IF Signal (304) to the ATSC HDTV receiver functional block (305).

FIG. 4 shows a single antenna being coupled to a plurality of tuners. A single TV Antenna (401) connects to a plurality of TV Tuners (403) by wired connections (402). The TV Tuner (403) outputs a Digital ATSC IF Signal (404) to the ATSC HDTV receiver functional block (405).

FIG. 5 shows a plurality of antennas being coupled to a plurality of tuners. A plurality of TV Antennas (501) connects to a plurality of TV Tuners (503) by wired connections (502). The TV Tuner (503) outputs a Digital ATSC IF Signal (504) to the ATSC HDTV receiver functional block (505).

FIG. 6 shows a single Wi-Fi ATSC TV antenna. The Wi-Fi ATSC TV Antenna (601) is connected to the TV Tuner (603) using a Wi-Fi connection (602). The TV Tuner (603) outputs a Digital ATSC IF Signal (604) to the ATSC HDTV receiver functional block (605).

FIG. 7 shows a Plurality Wi-Fi ATSC Antennas. A plurality of Wi-Fi ATSC TV Antennas (601) is connected to a plurality of TV Tuners (603) using Wi-Fi connections (602). The TV Tuner (603) outputs a Digital ATSC IF Signal (604) to the ATSC HDTV receiver functional block (605).

What is claimed is:

1. A method of Channel Impulse Response Estimation for terrestrial ATSC HDTV signal reception using the function of Weighted Combining Unit to optimally combine:
a. The function of Time Domain Iterative Channel Impulse Response Estimator, and
b. The function of Signal-To-Noise Ratio Estimator, and
c. The function of Frequency Domain Iterative Channel Frequency Response Estimator.

2. The method of claim 1 is associated with a single antenna being coupled to a single tuner.

3. The method of claim 1 is associated with a single antenna being coupled to a plurality of tuners.

4. The method of claim 1 is associated with a plurality of antennas being coupled to a plurality of tuners.

5. The method of claim 1 is associated with a single Wi-Fi ATSC TV antenna.

6. The method of claim 1 is associated with a plurality of Wi-Fi ATSC TV antennas.
